(19) United States
(12) Patent Application Publication
(10) Pub. No.: US 2005/0008286 A1
(43) Pub. Date: Jan. 13, 2005

(54) Manufacturing method of wavelength filter

(76) Inventors: Seh Won Ahn, Seoul (KR); Ki Dong Lee, Sungnam-si (KR); Sung Eun Lee, Seoul (KR)

Correspondence Address: BIRCH STEWART KOLASCH & BIRCH, PO BOX 747, FALLS CHURCH, VA, 22040-0747, US

(21) Appl. No.: 10/902,081

(22) Filed: Jul. 30, 2004

(30) Foreign Application Priority Data
Jun. 30, 2003 (KR) 2003/35490

(51) Int. Cl. G02B 6/28

(52) U.S. Cl. 385/24

(57) ABSTRACT

A manufacturing method of a wavelength filter includes the steps of: depositing on a substrate a lower clad layer and a core layer, each made from a polymer material; compressing the core layer with a mold to lithograph a pattern of the mold onto the core layer; stabilizing the lower clad layer and the core layer; separating the core layer from the mold; forming an upper clad layer on the core layer; and forming an electrode on the upper clad layer.

### BACKGROUND OF THE INVENTION

1. Field of the Invention

The present invention relates to a manufacturing method of a wavelength filter for use with an optical Wavelength Division Multiplexing (WDM) communication system.

2. Discussion of the Background Art

With the rapid increase of a variety of data including voice and image data, the world's attention has turned to studies about optical communication system for building a very high-speed broadband integrated communication network capable of integrating the data and transmitting and processing them at very high speed.

In particular, an optical WDM communication system respectively inputs different information to many light sources with different wavelengths, and multiplexes them and transmits the multiplexed data through one single optical fiber. Then the receiving end thereof demultiplexes the multiplexed signal and receives optical signals according to their wavelengths. Therefore, the bandwidth of for processing data can be greatly increased.

For the above benefits, the WDM technique is known as a core technique for the construction of very high-speed broadband communication network.

One of key parts used in the optical WDM communication system is a wavelength filter capable of filtering a light at specific wavelength to transmit a desired signal.

The typical example of a related art wavelength filter is a Fiber Bragg Grating (FBG) that is formed by irradiating ultraviolet rays to a photosensitive optical fiber through a phase masks.

The optical fiber is also used as a tunable wavelength filter capable of selecting a particular wavelength by applying heat or stress to the FBG.

Despite its superior characteristics, the FBG is not favored because it is difficult to reduce the size of the optical fiber, and the FBG is not easily integrated with another optical communication device.

For the above reasons, attempts have been made to develop a planar waveguide type wavelength filter.

The planar waveguide device is manufactured through a semiconductor fabrication process and thus, its productivity is very high and its small size makes easier to integrate with a number of devices.

Typical examples of the planar waveguide type device being commercially used are AWG (Arrayed Waveguide Grating), power splitters, variable optical attenuators, and optical switches.

In short, the optical WDM communication system can integrate many different light wavelengths per channel and transmit them, or demultiplex optical signals, or periodically perform optical switching between channels. When applied to a very high-speed optical communication system, therefore, it can process in excess of a terabyte of data.

The most important requirement for the optical device is that its optical loss is very low. This fact explains why silica is used mostly a material of the optical device.

In effect, the optical loss of the silica is as little as 0.01 dB/cm. However, one drawback of using silica for the manufacture of the optical device is that it should undergo a process performed at higher than 1000° C. to manufacture an optical waveguide.

As the answer to the above problems, polymer materials with little processing loss in an optical communication wavelength band have been developed, and devices benefiting from the polymer materials' excellent thermal and optical properties are already introduced.

Particularly, a lot of attention has been paid to the polymer materials because the optical device can be fabricated at very low cost, and the polymer-based optical device is easily integrated with other passive optical devices.

The variation in the refractive index with the temperature increase is 10 times greater in the polymer-based optical communication device than in the silica-based optical communication device. Thus, the polymer materials are more advantageous to fabricate thermal and optical devices with low-power consumption and thermal and optical device arrays.

Among other thermal and optical devices, arrayed variable optical attenuators and tunable wavelength filters are expected to have high competitiveness and benefit the most from the characteristics of the polymer materials.

FIG. 1 is a schematic diagram illustrating a related art planar waveguide type wavelength filter.

The planar waveguide type wavelength filter can be manufactured by forming a grating on a waveguide and causing the refractive index to periodically vary in the longitudinal direction of the waveguide.

When lights in N wavelengths λ₁, λ₂, λ₃, . . . λ_{N} are incident on the planar waveguide type wavelength filter, the wavelength lights satisfying the following condition are reflected and the other wavelength lights pass through the wavelength filter.

λ=2n_{eff}Λ, wherein n_{eff} denotes an average refractive index, and Λ denotes a grating period.

To manufacture this type of wavelength filter, a grating should be formed. In general, the grating is formed by lithographing (or imprinting) an interference pattern of ultraviolet rays on a photosensitive polymer through a phase mask and making periodic variations in the refractive index.

However, the lithography scheme using the phase mask requires the mask to be arrayed very accurately, and every polymer material is not necessarily appropriate for applying the lithography.

Another manufacturing method of the wavelength filter is a laser direct-write lithography in which a grating together with a waveguide are written directly into a polymer material sensitive to the laser beam.

The laser direct-write lithography is effective for forming fine patterns of high resolution at high speed.

The laser beam irradiated to the material causes a local temperature increase within a very short amount of time and as a result of this, a coherent or incoherent structure is formed on the surface of the material.

Periodicity of the coherent structure is determined in dependence of variables associated with laser beams and the material itself.

Laser beam associated variables include spot size and laser wavelength. Variables associated with substrate material include absorbance of an incident light, reflectivity, thermal diffusivity, and thermal conductivity.

The merits of the laser direct-write lithography are that the configuration of an optical system thereof is simple and it can be employed for polymer thin film patterning over a large area within a short amount of time. However, manufacturers should use polymers that are sensitive laser beams and are not easily lost in an optical communication wavelength band, and be careful with choosing cladding materials.

Moreover, the laser direct-write lithography is not productive at all, so it is inappropriate for mass production of wavelength filters and low-cost mass production for industrial applicability.

### SUMMARY OF THE INVENTION

An object of the invention is to solve at least the above problems and/or disadvantages and to provide at least the advantages described hereinafter.

Accordingly, one object of the present invention is to solve the foregoing problems by providing a manufacturing method of a wavelength filter for use with an optical WDM communication system, in which a waveguide together with a grating are formed easily with a mold.

The foregoing object is realized by providing a manufacturing method of a wavelength filter, which includes the steps of: depositing on a substrate a lower clad layer and a core layer, each made from a polymer material; compressing the core layer with a mold to lithograph a pattern of the mold onto the core layer; stabilizing the lower clad layer and the core layer; separating the core layer from the mold; forming an upper clad layer on the core layer; and forming an electrode on the upper clad layer.

Preferably, the mold is made by depositing a polymer layer on the substrate; patterning the polymer layer; plating a metal on the patterned polymer layer; and separating the metal from the polymer layer.

According to another aspect of the invention, the mold is preferably made by depositing a polymer layer on the substrate; patterning the polymer layer; coating a transparent polymer material on the patterned polymer layer; and stabilizing the transparent polymer material and separating the same from the polymer layer.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a schematic diagram illustrating a related art planar type wavelength filter;

FIG. 2A to FIG. 2E diagrammatically illustrate one embodiment of a manufacturing procedure of a mold for use with the manufacture of a wavelength filter according to the present invention;

FIG. 3A to FIG. 3E diagrammatically illustrate another embodiment of a manufacturing procedure of a mold for use with the manufacture of a wavelength filter according to the present invention; and

FIG. 4A to FIG. 4E diagrammatically illustrate a manufacturing method of a wavelength filter according to the present invention.

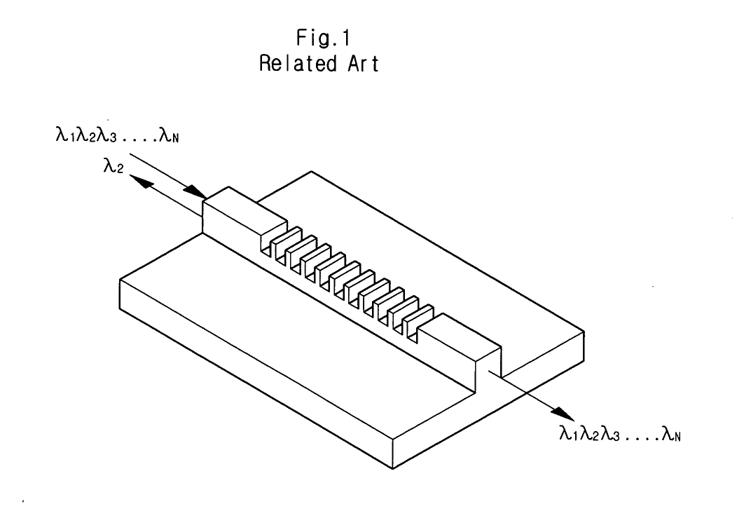

### DETAILED DESCRIPTION OF PREFERRED EMBODIMENTS

The following detailed description will present a preferred embodiment of the invention in reference to the accompanying drawings.

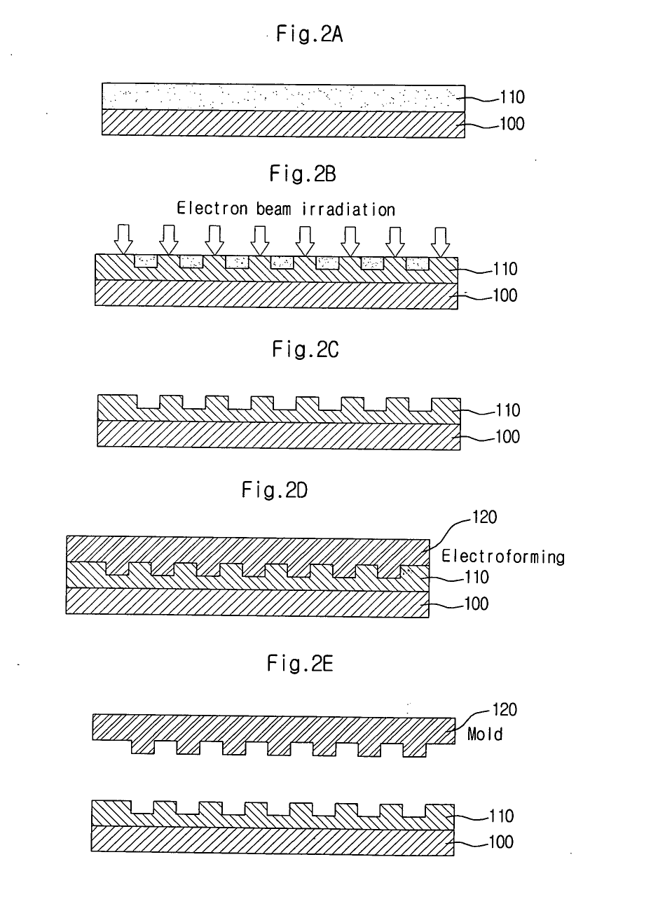

FIG. 2A to FIG. 2E diagrammatically illustrate one embodiment of a manufacturing procedure of a mold for use with the manufacture of a wavelength filter according to the present invention.

The mold has a concavo-convex shape opposite to the concavo-convex shape of a desired polymer fine pattern, and is preferably made from metallic materials with high strength, e.g., Nickel (Ni).

As shown in FIG. 2A, a polymer layer 110 is formed on a silicon substrate 100 by a spraying or spin coating method. In particular, the polymer layer 110 is deposited on the substrate 100 to a thickness of several micrometers.

As for the polymer layer 110 materials normally sensitive to electron beams such as PMMA (polymethylmethacrylate) are used.

Therefore, when the electron beams are irradiated over a certain part of the polymer layer, the part goes through multiplexing. This feature can be effectively used for forming a desired pattern through the irradiation of electron beams and developing the irradiated or non-irradiate part.

In the case that the polymer is a positive photoresist, the irradiated part under electron beams is dissolved in a developer. On the other hand, in the case that the polymer is a negative photoresist, the rest of the part where electron beams are not irradiated is dissolved in the developer.

After depositing the polymer layer 110 onto the substrate 100, electron beams are irradiated over the polymer layer 110, as shown in FIG. 2B, to draw a waveguide and a grating.

Later, as shown in FIG. 2C, the polymer layer 110 is soaked in the developer to develop a desired pattern.

In the embodiment of FIG. 2 a negative photoresist is used, so the parts where electron beams are not irradiated are developed.

Here, whether the waveguide is used as a single mode device or multi-mode device, width and height of the waveguide can range several μm to several tens of μm.

And, a grating period varies according to wavelengths. For example, the grating period ranges 400-600 nm in a wavelength band of 1550 nm. Also, the depth of the grating is determined by the refractive index of the polymer used in an end product of the device.

In general, the polymer layer 100 having a designated pattern as shown in FIG. 2 is called a master.

Referring now to FIG. 2D, a metal mold 120 is made on the master through an electroforming method.

The electroforming method takes advantage of electric properties to coat a thin metal film over the surface of an object. Usually nickel is used for the metal material.

Through the electroforming method, a thin metal film is formed on a patterned surface of the master. Thus, the opposite surface of the patterned metal mold 120 needs to be planarized.

Finally, as shown in FIG. 2E, the metal mold 120 is separated from the master.

Thusly manufactured metal mold's pattern has opposite concavo-convex shapes to those of the master (the polymer layer).

The metal mold 120 is utilized for the manufacture of a wavelength filter using a thermosetting (or heat-curing) coating technology.

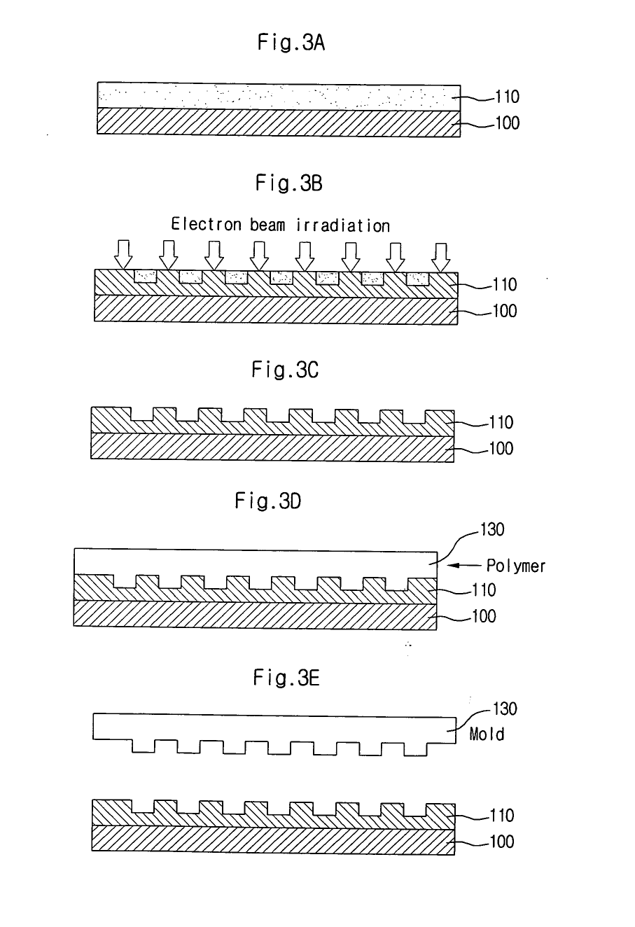

FIG. 3A to FIG. 3E diagrammatically illustrate another embodiment of a manufacturing procedure of a mold for use with the manufacture of the wavelength filter according to the present invention.

The mold according to the embodiment shown in FIG. 3A to FIG. 3E is used for the manufacture of a wavelength filter using a UV-curing coating technology.

As shown in FIG. 3A, a polymer layer 110 is formed on a silicon substrate 100 by a spraying or spin coating method. In particular, the polymer layer 110 is deposited on the substrate 100 to a thickness of several micrometers.

As for the polymer layer 110 materials normally sensitive to electron beams such as PMMA (polymethylmethacrylate) are used.

Therefore, when the electron beams are irradiated over a certain part of the polymer layer, the part goes through multiplexing. This feature can be effectively used for forming a desired pattern through the irradiation of electron beams and developing the irradiated or non-irradiate part.

In the case that the polymer is a positive photoresist, the irradiated part under electron beams is dissolved in a developer. On the other hand, in the case that the polymer is a negative photoresist, the rest of the part where electron beams are not irradiated is dissolved in the developer.

After depositing the polymer layer 110 onto the substrate 100, electron beams are irradiated over the polymer layer 110, as shown in FIG. 3B, to draw a waveguide and a grating.

Later, as shown in FIG. 3C, the polymer layer 110 is soaked in the developer to develop a desired pattern.

Here, whether the waveguide is used as a single mode device or multi-mode device, width and height of the waveguide can range several μm to several tens of μm.

And, a grating period varies according to wavelengths. For example, the grating period ranges 400-600 nm in a wavelength band of 1550 nm. Also, the depth of the grating is determined by the refractive index of the polymer used in an end product of the device.

In general, the polymer layer 100 having a designated pattern is called a master.

Referring now to FIG. 3D, a polymer mold 130 is made on the master by pouring polymer materials transparent to ultraviolet rays, or spin coating the master.

PDMS (polydimethylsiloxane) is used for the transparent polymer material.

Finally, as shown in FIG. 3E, the metal mold 130 having a desired pattern is obtained by separating a solid polymer film that is coated on the master.

Therefore, using the metal mold 120 or the polymer mold 130, the wavelength filter is manufactured.

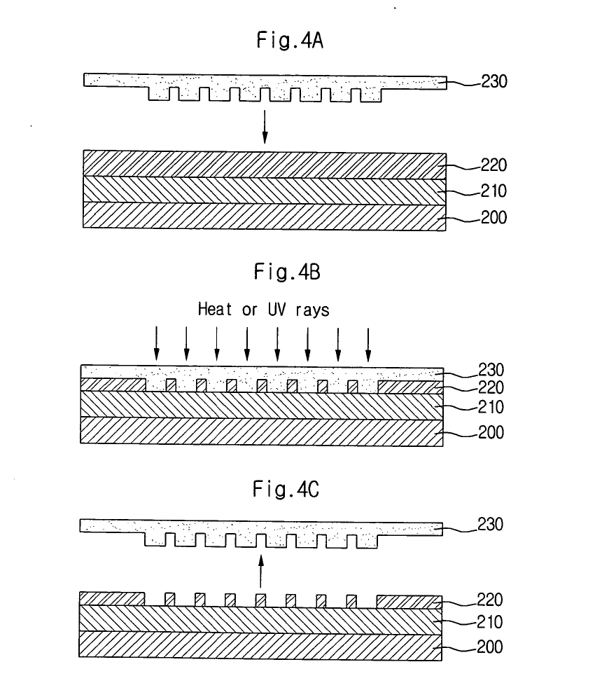

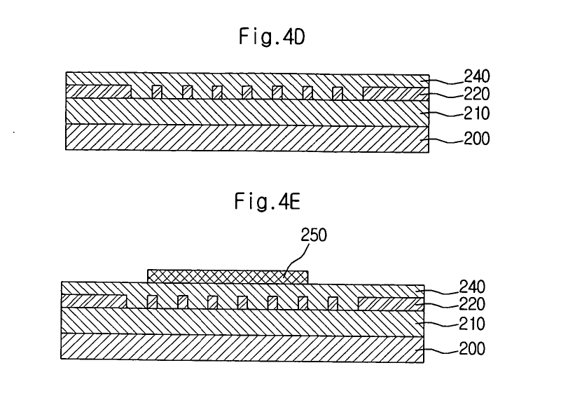

FIG. 4A to FIG. 4E diagrammatically illustrate a manufacturing method of the wavelength filter according to the present invention.

As shown in FIG. 4A, two polymer layers 210, 220 are spin coated on the silicon substrate 200, thereby forming a lower clad layer 210 ad a core layer 220.

Here, the refractive index of the lower clad layer 210 is smaller than that of the core layer 220 so that light can be transmitted through the core layer 220.

Later, as shown in FIG. 4B, a pre-made mold 230 compresses the core layer 220 to lithograph the mold pattern onto the core layer 220.

If the polymer is a heat-curing material, the metal mold is employed. However, if the polymer is a UV-curing material, a transparent polymer mold is employed.

Thus, the polymer is stabilized by applying heat or irradiating ultraviolet rays to the mold 230.

Afterwards, the mold 230 is separated from the core layer 220, as shown in FIG. 4C.

Then the pattern of the mold 230 is lithographed onto the core layer 220. More specifically, the concavo-convex shapes patterned on the core layer 220 are in opposite positions from the concavo-convex shapes patterned on the mold 230.

As shown in FIG. 4C, an upper clad layer 240 is spin coated on the core layer 220.

The upper clad layer 240 has the same refractive index with the lower clad layer 210.

Thusly manufactured wavelength filter reflects a specific wavelength light that is defined by the period and depth of the grating and the refractive index of the polymer being used.

Wavelength of the reflected light can be varied by the tunable wavelength filter. Referring to FIG. 4E, the tunable wavelength filter is manufactured by forming a metal electrode (e.g., gold electrode) 250 on the upper clad layer 240 that is disposed on the grating.

As shown in FIG. 4E, the tunable wavelength filter is driven by heat energy generated from the current traveling in the metal electrode 250.

Finally, the end product of the tunable wavelength filter is manufactured by connecting an optical fiber to an input/output waveguide and packaging (or housing) them.

In conclusion, according to the manufacturing method of the wavelength filter of the invention, the pre-made mold is used to imprint the waveguide and the grating into the polymer only once. Therefore, the cost of manufacture is much reduced and the wavelength filters can be mass produced.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1. A manufacturing method of a wavelength filter, the method comprising the steps of:
depositing on a substrate a lower clad layer and a core layer, each made from a polymer material;
compressing the core layer with a mold to lithograph a pattern of the mold onto the core layer;
stabilizing the lower clad layer and the core layer;
separating the core layer from the mold;
forming an upper clad layer on the core layer; and
forming an electrode on the upper clad layer.

2. The method according to claim 1, wherein the mold is made by:
depositing a polymer layer on the substrate;
patterning the polymer layer;
plating a metal on the patterned polymer layer; and
separating the metal from the polymer layer.

3. The method according to claim 2, wherein the metal is nickel (Ni).

4. The method according to claim 2, wherein an electroforming technology is used for plating the metal on the polymer layer.

5. The method according to claim 2, wherein the polymer layer is made from PMMA (polymethylmethacrylate).

6. The method according to claim 2, wherein the polymer layer is patterned by forming a waveguide and a grating on the polymer layer.

7. The method according to claim 1, wherein the mold is made by:
depositing a polymer layer on the substrate;
patterning the polymer layer;
coating a transparent polymer material on the patterned polymer layer; and
stabilizing the transparent polymer material and separating the same from the polymer layer.

8. The method according to claim 7, wherein the polymer layer is made from PMMA (polymethylmethacrylate).

9. The method according to claim 7, wherein the transparent polymer material is made from PDMS (polydimethylsiloxane).

10. The method according to claim 7, wherein the polymer layer is patterned by forming a waveguide and a grating on the polymer layer.

11. The method according to claim 1, wherein the stabilizing the lower clad layer and the core layer is realized by applying heat to the mold.

12. The method according to claim 1, wherein the stabilizing the lower clad layer and the core layer is realized by irradiating ultraviolet rays to the mold.

13. The method according to claim 1, wherein the lower clad layer and the upper clad layer are made from a polymer with the same refractive index.

14. The method according to claim 1, wherein the refractive index of the lower clad layer is smaller than that of the core layer.
